(19) United States
(12) Patent Application Publication
(10) Pub. No.: US 2003/0203104 A1
(43) Pub. Date: Oct. 30, 2003

(54) Process for forming a coating layer on a base support, optionally in the form of a coating pattern

(76) Inventors: Gerardus Johannes Crommentuyn, Lottum (NL); Hendrik Wieringa, Grubbenvorst (NL)

Correspondence Address: BIRCH STEWART KOLASCH & BIRCH, PO BOX 747, FALLS CHURCH, VA, 22040-0747, US

(21) Appl. No.: 10/422,719

(22) Filed: Apr. 25, 2003

(30) Foreign Application Priority Data
Apr. 26, 2002 (NL) 1020490
May 17, 2002 (NL) 1020616

(51) Int. Cl. B05D 3/02; B05D 1/12

(52) U.S. Cl. 427/180; 427/385.5

(57) ABSTRACT

A process for applying a uniform coating layer optionally image-wise, to a base support, which includes the steps of forming on a soft elastomer surface a substantially monograin layer of thermoplastic powder, heating the powder to make it tacky, transferring the powder under pressure to a base support, and heating the base support to a temperature until a uniform layer flows out over the base support. The powder used contains a cross-linkable polyester resin having a number-averaged molecular weight between 2,000 and 10,000.

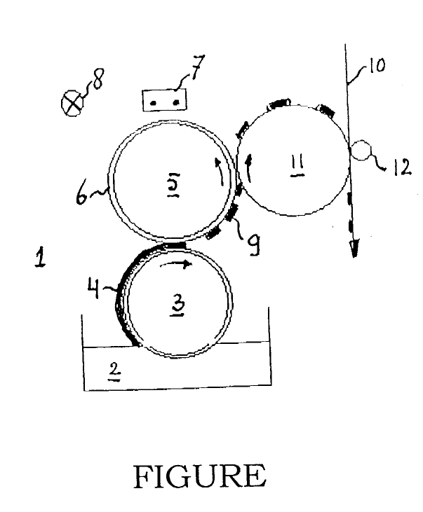

### BACKGROUND OF THE INVENTION

This non-provisional application claims priority under 35 U.S.C. §119(a) on Patent Application Nos. 1020490 and 1020616 filed in The Netherlands on Apr. 26, 2002 and May 17, 2002, respectively, both of which are herein incorporated by reference.

### FIELD OF THE INVENTION

The present invention relates to a process for forming a firmly anchored, uniform, thin coating layer on a base support. More particularly, the present invention relates to a meltable or softenable powder for use in such a process. The base support for use in the process may be of various kinds and can consist of, for example, metal, glass, plastic or wood. The coating layer can also be formed in the form of a thin closed layer on the base support and serve, for example, as a protective layer optionally having the function of a coloring layer (paint layer). The coating layer can equally be a layer which is applied only to specific parts of the surface of the base support and serve as a decorative layer or as an inscription or text. In addition to wet techniques for coating surfaces of all kinds, dry powder techniques have in recent years become increasingly important. In these dry powder techniques, the surface for coating is covered with a uniform layer of powder, optionally image-wise, whereafter the powder is softened by heating so that it flows out in the form of a uniform closed layer. Various techniques have been developed for applying the powder to the base support, such as spraying via a raster, electrostatic coating by charging the base support electrostatically or by applying a suitable potential thereto and electrostatically causing the powder to stick to the surface, the powder having an opposite electrical charge or being (made) electrically conductive. For applying a powder in the form of a pattern (image-wise), a process can be used in which a charge image is formed on the base support (the latter being insulating or provided with an insulating top layer), for example by writing with a set of pin electrodes or by charge image transfer, the charge image being developed with powder and the powder image being fixed by heating.

The present invention also relates to a general method and a toner composition for applying coatings in a desired pattern on a substrate in the form of a shadow mask for a cathode ray tube (CRT).

The main function of the shadow mask in a color picture tube is that of color selection. This means that each of the three electron beams (red, green and blue) can only hit the right color on the screen. Thus, the holes in the shadow mask must be very accurately positioned towards the phosphor pattern on the screen under all conditions.

The shadow mask in the tube is positioned in a frame or diaphragm that is mounted by welding or clamping on pins in the screen. About 20% of the shadow mask area is provided with holes. This means that about 80% of the generated electrons will hit the shadow mask surface. This will heat up the shadow mask. This heating up will result in an expansion of the shadow mask and since the mask is welded to the frame, this will result in a doming of the mask. Because of the phenomonen doming, the position of the holes towards the phosphor pattern on the screen will change and will lead to a misalignment of the holes towards the phosphor pattern which causes an undesired color impurity of the picture on the screen.

The doming of the shadow mask can be reduced by:

1. Using a shadowmask material with a low thermal expansion coefficient;

2. Using a shadowmask material with a high thermal conduction coefficient;

3. Using a material with a high thermal emission coefficient on the shadowsmask; and

4. Using a material with a high electron backscattering coefficient on the shadowmask.

The application of coatings on a shadow mask is utilized to improve items 3 and 4.

The production of a shadow mask is as follows:

1. Applying holes in a metal sheet by a photolitographic process and etching;

2. Providing an annealing treatment of the metal sheet at at (Temp. >800° C. in a reducing atmosphere);

3. Forming a mask by a drawing process, giving the mask the desired curved shape;

4. Degreasing to remove the oil used in the mask drawing process;

5. Blackening in an oxidizing atmosphere to apply the IR-emission layer by the formation of an oxide layer; and

6. Assembling the curved sheet to the frame.

To improve the thermal emission coefficient the shadow mask is provided with a metal oxide layer which is obtained by heating the mask in a well controlled oxidising atmosphere to 600° C.-700° C. (Step 5)

To improve the electron backscattering, the gun side of the mask is provided with a layer of a material with a high atomic number, with Z≧50, such as bismuth, tungsten, lead, etc. or compounds of these elements. Most widely used is Bismuth oxide but also Lead glass frit can be used. The preferred coating thickness is 0.5 micron to 5 micron

Most picture tube manufacturers apply the material by a spraying process on the mask after mask drawing and assembling, but also other methods like screen printing and sputtering can be used.

Drawbacks of the prior art methods involving a spraying process is that it process is very difficult to control and can lead to blocked mask holes resulting in expensive tube rejections in the production process. Sputtering, on the other hand, is a process that requires a very high investment in equipment. Screen printing, is also an expensive process because the material consumption per mask is considerably higher and the process is rather complicated in mass production.

The coating of the emission layer and the backscattering layer on the shadow mask with the method of the present invention is normally carried out after annealing but before mask forming. The reason for this is that then the shadow mask will still be flat which fascilitates the coating process. On the other hand, however, the coating must then be such that it easily can withstand the drawing process without any damage to the coating. The coating must accordingly also be resistant to the subsequent washing and degreasing step.

### BACKGROUND ART

For many applications, particularly for applying patterns or images to a base support, it is necessary or at least very desirable for just a thin, preferably mono-grain layer powder to be applied to the base support, which thin powder layer is then melted by heating to form a thin, homogeneous, closed film layer which is anchored firmly on the base support. A thin, uniform powder layer can be formed on the base support by means of a transfer method wherein a thin powder layer is first formed on a relatively soft elastomer surface, consisting for example of silicone rubber or perfluoropolyether (PFPE), the powder layer being a mirror image of the pattern to be formed on the base support, the powder is then softened by heating while it is located on the elastomer surface so that it becomes tacky and the tacky powder is transferred by pressure to the base support, which is optionally heated. After the powder has been transferred to the base support, the assembly is heated to a temperature (e.g. 150° C. or more) at which the powder flows out to form a uniform, cohesive layer permanently connected to the base support. After the cohesive layer has been formed in this way, a hardening step is preferably carried out to cross-link the binding agent and thus improve the mechanical resistance of the layer.

Powders for use in such a process, namely powders which finally are required to form an extremely thin, closed layer adhering well to the base support, must meet high requirements. As a powder they must have good flow properties in order to be applied in a uniform mono-grain layer and upon heating, even in the event of a high solids content, such as a color pigment, they must melt to form a thinly liquid melt which flows well over the base support to form a uniform layer. The binding agent in the powder must be cross-linkable, but the cross-linking reaction must not occur in a really appreciable degree in the stage in which the powder is heated to form a well-flowing mass in order to form a thin uniform layer on the base support. Furthermore, the powder must be chemically stable during relatively long periods of storage at temperatures to 35-45° C., this being the temperature which may prevail in the processing apparatus.

### SUMMARY OF THE INVENTION

The present invention relates to a process and particularly to a powder for use in the process, whereby thin, uniform, closed layers can be formed on a base support.

According to the process of the present invention, there is applied to an elastomeric surface in the form of a mirror image of the final pattern to be formed on the base support, a substantially mono-grain layer of powder containing a thermoplastic binding agent, the powder in the mono-grain layer is made tacky by heating while it is situated on the elastomer surface, the tacky powder is transferred by pressure to the base support, the base support with the powder transferred thereon is then heated to a temperature at which the powder flows out to form a uniform layer and the binder is cross-linked in the layer. The present invention uses a powder which contains a cross-linkable substantially linear polyester resin having a weight-averaged molecular weight of about 2000 to 10000. The polyester resin in the powder used according to the present invention is a cross-linkable polyester resin, the cross-linkability being obtained by providing the resin itself with reactive groups which bring about the cross-linking reaction at elevated temperature and/or by irradiation with actinic light, for example UV light, or is mixed with a component, e.g. a second resin, which contains groups which, at an elevated temperature, react with reactive groups of the polyester resin, for example a resin which contains carboxylic and/or hydroxy groups.

Preferably, the toner powder contains a substantially linear polyester resin with a weight-averaged molecular weight of between 2000 and 10000, which polyester resin or mixture of such resins can be mixed, according to a further preferred embodiment, with a relatively low molecular weight epoxy resin having a number-averaged molecular weight of less than 1500 and an epoxy group content of less than 60 mmol of free epoxy groups per kg.

It has been found that polyester resins of the type referred to hereinabove, upon heating, first form a well-flowing melt and then on further heating to a temperature of at least about 200° C. cross-link by intermolecular reaction. After cross-linking, a layer is formed with a high mechanical resistance is sufficiently elastic for the support on which the layer is applied to be able to bend. This advantageous property applies even further if the polyester resin is mixed with low-molecular epoxy resin as defined hereinabove.

The epoxy group content in this epoxy resin must not be too high (e.g. less than 60 mmol/kg) because otherwise there is the risk that the cross-linking reaction will occur too soon and hence the flowing of the resin to form a uniform layer leaves much to be desired.

The polyester resin is preferably derived from a dicarboxylic acid and a diol, preferably an etherified bisphenol. The dicarboxylic acid can be saturated or unsaturated and can include, for example, fumaric acid, maleic acid, malonic acid, succinnic acid, glutaric acid and cyclohexane dicarboxylic acid and mixtures of such acids. Also suitable are aromatic dicarboxylic acids such as phthalic acid, terephthalic acid and isophthalic acid, and also mixtures of aromatic dicarboxylic acids and mixtures of one or more aromatic dicarboxylic acids with one or more aliphatic saturated or unsaturated dicarboxylic acids.

The diol is preferably an etherified bisphenol. Typical examples are polyoxyethylene(2)-2,2-bis(4-hydroxyphenyl)-propane, polyoxypropylene(3)-2,2-bis(4-hydroxyphenyl)-propane, polyoxypropylene(2)-2,2-bis(4-hydroxyphenyl)-propane, polyoxypropylene(3)-bis(4-hydroxyphenyl)-sulphone, polyoxypropylene(2)-bis(4-hydroxyphenyl)thioether and mixtures of such diols.

The number-averaged molecular weight of the polyester resin is 2000-10000. In this range the resins have the most suitable visco-elastic properties required in the process according to the present invention, to transfer the powder layer which has been thermally made tacky to the base support, under pressure, the transfer being substantially quantitative from the elastomeric surface. The polyester resin (or mixture of polyester resins), can advantageously be mixed with a cross-linking agent preferably consisting of a low molecular epoxy resin with a number-averaged molecular weight of less than 1500 and a reactive epoxy group content of preferably not more than 60 mmol per kg. Suitable epoxy resins are the available low-molecular weight epoxy resins, for example, those commercially available from Shell Nederland B.V., under the name Epikote 828, 838 and 1001. The content of free epoxy groups in these commercially available resins is higher than the preferred maximum of 60 mmol per kg. As a result, some of the reactive epoxy groups are deactivated by reaction with a monofunctional reagent in order to obtain a resin which meets the requirement of a maximum of 60 mmol epoxy groups per kg. The monofunctional reagent for deactivating the excess of reactive epoxy groups can be a monofunctional alcohol or phenol or a monofunctional carboxylic acid. Suitable monofunctional reagents are phenol, O-tert.butylphenol, p-sec. butylphenol, p-cyclohexylphenol, α-naphthol, β-naphthol, octylphenol, nonylphenol, phenylacetic acid, diphenylacetic acid, p-ter. butyl-benzoic acid, p-isopropylbenzoic acid. The relatively low content of reactive epoxy groups is necessary to ensure that the resin powder at the high temperature of fixing it on the base support, has for the first time the opportunity to flow as a thin melt into a uniform layer on the base support and only then to cross-link to form a permanent layer.

The ratio of polyester resin to epoxy resin in the powder can vary within fairly wide limits and is preferably between 60:40 and 30:70.

Instead of a mixture of polyester resin and thermal cross-linking agent, according to the present invention, it is possible to use a powder containing a polyester resin which contains cross-linkable groups in its molecular structure so that the resin can harden by an intermolecular reaction initiated thermally or in some other way.

Very suitable polyester resins are polyester resins or compositions which contain polyester resins which can be cross-linked by UV-light. Examples include unsaturated polyesters derived from an unsaturated dicarboxylic acid such as fumaric acid or maleic acid and mixed with a crystalline cross-linking agent based on a vinyl ether, (metha)acrylated polyesters optionally combined with a crystalline cross-linking agent, and unsaturated polyesters mixed with a solid urethane acrylate. In the UV-cross-linkable compositions, the polyester resins present have a number-averaged molecular weight of 2,000-10,000.

In addition to the resin, the powder contains coloring materials such as carbon black, organic or inorganic pigment, dye and/or other materials selected in dependence on the intended use with the powder. For example, the powder may contain magnetic or magnetisable pigment when magnetically detectable patterns are to be applied to the base support. Bismuth oxide (Bi2O3) can be added preferably together with any adjuvants such as low-melting glass enamel (adhesion improver) when an electron-reflecting coating is to be applied, for example in the production of shadow masks for image tubes. The glass enamel, preferably a lead or bismuth containing enamel, can be added to ensure good adhesion of the layer after the blackening process of the shadow mask, since during blackening at elevated temperatures the toner resin will decompose and burn away. The content of pigment in the powder may be up to 60% by weight or even more. Even with this high solid content, the powder has been found to flow out well to form a closed layer when heated to about 150° C.

The particle size of the powder can vary within wide limits and is preferably between 2 and 60 micrometers. One special possibility of the process according to the present invention is that the layer thickness finally required can largely be controlled by the choice of the particle size of the powder. For example, layers of just a few micrometers thickness can be formed by forming the mono-grain layer with a powder having an average particle size of 5 to 6 micrometers and a particle size spread between, for example, about 4 and 10 micrometers, while thicker layers can be formed by using a powder having a larger average particle size and spread (for example 15-16 and 12-20 micrometers, respectively). In the process according to the present invention the powder with the composition described hereinabove is formed in a thin substantially mono-grain layer on a soft elastomeric surface. The soft elastomeric surface consists, for example, of a layer of silicone rubber or other rubber-like material, for example perfluoropolyether, 50 to 200 micrometers thick, applied to a suitable support or base. The hardness of the elastomeric material is preferably between 15 and 80 degrees Shore A. Suitable silicone rubbers are described in, inter alia, NL-A-8801669. A mono-grain layer formed as a solid surface can be formed on the elastomer surface by pressing the elastomer surface, which is optionally constructed as an (optionally) endless belt or roller, against a moving belt or roller on which a layer of powder is present. As a result of the pressure a mono-grain layer of powder passes over to the elastomeric surface. If the powder is to be applied to the base support in the form of a specific (image) pattern, the powder is formed on the elastomer surface as a mirror image of the pattern. This can be effected by forming on an electro(photo)graphic or magnetic image-forming medium a latent electrostatic or magnetic image in the form of a pattern corresponding to the pattern required on the base support, making this pattern visible with the powder used according to the invention, and then pressing the image-forming medium with the powder image pattern present thereon against the elastomer surface so that a mono-grain layer forms on the elastomer surface as a mirror image of the final pattern required. The powder on the elastomer surface is heated by means of one or more external heating sources, e.g., by heating sources disposed inside the roller covered with elastomer material or, if a belt is used, within the trajectory of the belt. In order to make the powder thermally tacky, the elastomer surface is heated to a temperature of about 80 to 120° C. The base support to which the image is to be transferred by pressure contact can advantageously also be heated somewhat, for example to a temperature of between 50° and 100° C. A linear pressure of 800 to 1500 N/m is used for the pressure transfer from the elastomer surface to the base support. The pressure transfer of the powder from an image-forming medium to the elastomer surface can be effected at a somewhat lower pressure, also depending on the hardness of the elastomer surface. The required transfer result is achieved throughout at a linear pressure of 600-800 N/m. After the powder has been applied to the base support, the base support is heated to a temperature at which the powder flows out to form a thin uniform layer. After the uniform closed layer has formed, the binder is cross-linked by heating the base support to a temperature at which the cross-linking reaction takes place, or by irradiating the resin layer, optionally with heating, using actinic light, for example UV light. If the powder contains a thermally cross-linking polyester resin, the polyester resin or the composition containing the polyester resin is preferably so selected that the cross-linking reaction takes place at a temperature just above the temperature at which the powder transfer to the base support takes place. If a photochemically cross-linkable polyester resin or polyester resin-containing composition is used, it may also be necessary to heat the resin during or prior to the irradiation with actinic light, in order to obtain a fast progress of the photochemical hardening reaction. Of course, when a photochemically cross-linkable resin is used, the process preceding the cross-linking step should be carried out under conditions at which premature photochemical cross-linking of the resin is avoided.

When use is made of the process according to the present invention, a mechanically resistant but reasonably elastic layer is thus formed which allows deformation (bending) of the base support without shearing or directly becoming detached from the support. For some applications, after the layer has been cross-linked and the base support has been formed in the required shape (bent), the layer is further heated to a higher temperature in order to completely fire the cross-linking agent and thus form a ceramic or glass-like layer on said support. This after-heating is carried out, for example, when the process according to the invention is used for the manufacture of shadow masks of CRT tubes.

As mentioned hereinabove, the method according to the present invention can advantageously be used for the manufacture of shadow masks for use in a CRT.

Heating and melting of the resin may be carried out at any time after applying the toner to the shadow mask. In a preferred embodiment, however, melting of the resin is performed by means of the transfer roll or the shadowmask transfer device, which suitably may be electrically heated. By this method, the coating is adhered to the shadow mask substrate immediately after application. By melting the resin the toner grains on the edge of the holes also melt and flow away from the hole. This gives a very sharp defined maskhole. By this phenonenom even masks for monitor displays with very small maskholes (≦120 micron) can be coated. It is to be understood, however, that the melting of the resin may also be performed by simply heating the substrate to the melting temperature of the resin when the substrate has left the transfer roll.

The coating thickness on the shadowmask in the tube can be adjusted by the grain size of the toner and the quantity of inorganic material in the toner. The preferred grain size of the toner is 5-30 micron. The preferred quantity of inorganic material in the toner is 25-75% by weight.

Subsequent to the application and adhering of the coating, the substrate is formed in the desired shape. Normally the coating can withstand the forming process without any damage. In certain cases, however, the forming or drawing process of the substrate has to be performed with the substrate heated to a temperature above the melting temperature of the resin in the coating. This applies e.g. to shadow masks made of so called Invar-metal. When forming a shadow mask of that material, the mask is heated to about 180° C. which is well above the melting point for most hot melt resins. Accordingly the resin in the coating will melt and contaminate the mold for mask forming. This is not acceptable and will lead to the rejection of the shadow mask. To overcome this problem the substrate, according to an embodiment of the present invention provided with a preferred toner composition, is heat treated at 300° C.-450° C. for a short period prior to forming. The period may, for example range from 5 to 300 seconds, preferably 10 to 120 seconds. However, the optimum temperatures and the length of the period may vary depending on the resin which is used. During this heat treatment, crosslinking and some carbonization of the organic material occurs with the effect that the resin will not melt at the subsequent forming process. Another advantageous effect is that by this heat treatment, the coating becomes more resistant to an alkaline degreasing process (pH>12) or a tri vapor degreasing process which often follows upon the forming process in order to remove oil and grease from the substrate. Without the heat treatment such an alkaline or tri degreasing process has a tendency to attack the coating, resulting in bad adhesion towards the substrate.

The present invention will now be further explained by way of example and with reference to the Figure which is a schematic side view of an arrangement for the coating of a substrate, illustrating the method according to the present invention.

In the figure a supply device 1 delivers the toner 2 in a dry, pulverous state to the circumferential surface of an application roll 3, such that a toner layer 4 is continuously formed on the roll surface. The application roll 3 is very near a photoconductive roll 5, provided with a photoconductive layer 6, and the rolls are rotated in conformity with each other.

By means of a corona charging device 7, the photoconductive layer 6 is positively charged during rotation of the photoconductive roll 5. In a region after the corona charging device 7, in relation to the direction of rotation, a light exposing device 8 is positioned. By means of the light exposing device 8, the photoconductive layer 6 is exposed to light in a desired pattern, resulting in a discharging of the light exposed areas of the photoconductive layer (illustrated by removed plus signs).

The application roll 3 is positioned near the photoconductive roll 5 in a region after the light exposing device 8. The electrostatic charge pattern on the photoconductive roll and the electrostatic behaviour of the toner has the effect that the toner adheres in a desired pattern 9 to the charged areas of the photoconductive roll.

The toner pattern 9 is subsequently transferred to a substrate by means of a transfer roll 11 which bears against the photoconductive roll 5 as well as the substrate 10. To fascilitate transferring of the toner pattern 9, the transfer roll 11 preferably is provided with a rescilient surface layer. During the process the substrate is introduced between the transfer roll 11 and a bearing roll 12.

As previously mentioned, the toner preferably is subjected to a heat treatment of about 60° C.-120° C. and slightly pressed from the transferring roll 11. Also, the coated substrate may be subjected to further after-treatment, such as a heat treatment of between 300° C.-450° C. for about 5 to 300 seconds to enhance the ability to withstand high temperatures in a possible, subsequent forming process.

Thus, the present invention relates to a method for applying a patterned coating on a substrate 11, preferably a shadow mask. The method comprising the steps of; charging a photoconductive roll 5 with a negative charge; exposing the photoconductive roll to light in the desired pattern; applying a pulverized toner 2 to the photoconductive roll, wherein the toner will adhere only to the non-light exposed, charged areas; and transferring the toner in the desired pattern 9 onto the substrate. The present invention also contemplates a toner composition adapted to carry out the present method.

This process is not restricted to the application of coatings on the gun side of the mask such as the described backscatter-layer but can also be used for layers on the screen side. If a layer with low-atomic number materials, such as Boron or carbon or compounds from these elements, is applied on the screenside, the contrast of the tube will be improved due to a lower backscattering of the electrons between the mask and the screen. Furthermore, if a material with a low coefficient of friction is used in the toner on the screen side of the mask, no drawing oil is needed anymore. Furthermore there is no need for the tri or alkaline degreasing process, which leads to a more economic production process.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

### EXAMPLE

A power having a particle size of between about 5 and 15 micrometers and containing:

| | |
|---|---|
| Carbonyl iron | 1.5 kg |
| Bismuth oxide (Bi2O3) | 4.8 kg |
| Epikote 828, the reactive epoxy group | 2.2 kg |
| content of which was reduced to about | |
| 4 mmol/kg by reaction with p-cumyl- | |
| phenol | |
| Polyester resin (Mn 8300) of bisphenol | 1.5 kg |
| A and adipic acid and terephthalic acid | |
| in the mol ratio of 27:73 | |

was prepared by melting the thermoplastic resin in a manner known per se, homogeneously distributing the pigments in the resin melt, cooling the melt to form a solid and grinding and screening the solid.

This powder was then covered with a layer of carbon black in accordance with the process as described in Netherlands patent No. 168347, to give an electrically conductive powder having a resistivity of 5.3×10³ ohm.m.

A powder surface was formed with the resulting powder on a standard organic photoconductor, by charging the latter electrostatically and then developing the charge pattern in a magnetic brush developing device with the powder.

The powder surface was transferred by pressure (linear pressure about 800 N/m) to a 100° C. heated roller having a diameter of about 100 mm and consisting of a steel core with an approximately 1.7 mm thick substrate of pigmented RTV-silicone rubber thereon and an approximately 50 micrometer thick top layer of second RTV-silicone rubber thereon, all as described in Example 1 of Netherlands patent application No: 8801669. A substantially monogram layer of powder was thus formed on the roller. After the powder had become tacky, it was transferred under pressure to a base material heated to about 90° C. for forming shadow masks consisting of INVAR. The thin powder layer transferred to the INVAR base material was then heated to 150° C. for about 5 minutes so that the powder flowed into a thin closed layer, leaving the fine openings of the shadow mask base material substantially completely free. The shadow mask was heated to 650° C. in a CO/CO2 atmosphere in order to fire the resin. In this way a shadow mask was obtained with completely free openings otherwise covered with a thin uniform electron-reflecting layer.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A process for applying a thin, uniform coating layer to a base support which comprises:
depositing a powder containing a meltable resin in a thin, substantially monogram layer on a soft elastomeric surface;
heating the powder present on the elastomeric surface to render it tacky;
transferring the tacky powder by pressure to a final base support;
heating the tacky powder to a temperature at which the powder flows into a uniform layer over the support, wherein the powder contains a cross-linkable polyester resin which has a number-averaged molecular weight of between about 2000 and 10,000; and
after the formation of the uniform layer, the resin is cross-linked.

2. The process according to claim 1, wherein the polyester resin is derived from an etherified bisphenol.

3. The process according to claim 1, wherein the powder contains an epoxy resin having a number-averaged molecular weight below 1500 and an epoxy group content of less than 60 m.mol/kg.

4. The process according to claim 3, wherein the powder contains the polyester resin and the epoxy resin in a weight ratio of between 60/40 and 30/70.

5. The process according to claim 1, wherein the powder contains a polyester resin cross-linkable by actinic light.

6. The process according to claim 1, wherein the powder contains a pigment and/or a dye as an additive.

7. The process according to claim 6, wherein the powder contains a magnetisable pigment.

8. The process according to claim 6, wherein the powder contains a pigment which forms an electron-reflecting layer.

9. The process according to claim 8, wherein the powder contains bismuth oxide.

10. The process according to claim 8, wherein after the resin has been cross-linked the support is heated to a temperature at which the resin is fired.

11. The process according to claim 1, wherein the tacky powder is heated by heating the base support.

12. The process for according to claim 1, wherein the thin, uniform coating layer is applied to the base support as an image.

13. A composite comprising a thin, cohesive layer permanently connected to a base support, said layer containing a cross-linked polyester resin binder having a number-averaged molecular weight of about 2000 to 10,000.

14. The composite of claim 13, wherein the base support is selected from the group consisting of metal, glass, plastic and wood.

15. The composite of claim 13, wherein the polyester resin is mixed with an epoxy resin having an epoxy group content of less than 60 mmol/kg.

16. The composite of claim 15, wherein the epoxy resin has a number-averaged molecular weight of less than 1500.

17. The composite of claim 13, wherein the polyester resin is derived from a dicarboxylic acid and an etherified bisphenol.

18. A method for coating a mask for use as a CRT-shadow mask which comprises,
forming a toner layer on a first member by imparting an electrical charge area on said first member and depositing a resin-toner layer on said charge area,
transferring said toner layer to a soft elastomeric surface layer with the application of pressure between said first member and said elastomeric surface layer,
heating the toner layer on the elastomeric surface layer to render it tacky,
transferring the tacky powder by pressure to a shadow mask base support, and
heating the toner on said shadow mask base support to a temperature of at least 300° C. for a period of time sufficient to at least partially carbonize the resin in said toner.

19. The method of claim 18, wherein the toner comprises a cross-linkable polyester resin which has a number-averaged molecular weight of between about 2000 and 10000.

20. The method of claim 19, wherein the toner further contains an epoxy resin having a number-averaged weight of less than 1500 and an epoxy group content of less than 60 m.mol/kg.

21. The method of claim 17, wherein the toner includes a metal or metal containing component in which the metal-atomic number is at least 50.

22. The method of claim 21, wherein the toner comprises bismuth oxide.

23. The method of claim 21, wherein the toner comprises lead glass frit.

24. The method of claim 21, wherein the toner additionally contains a glass enamel.

25. The method of claim 24, wherein the glass enamel comprises lead or bismuth.
